(19) United States
(12) Patent Application Publication
(10) Pub. No.: US 2002/0184233 A1
(43) Pub. Date: Dec. 5, 2002

(54) Enterprise-wide computerized document template management system

(75) Inventor: Ulf Schneider, Paderborn (DE)

Correspondence Address: David R. Irvin, IBM Corporation T81/503, PO Box 12195, Research Triangle Park, NC, 27709, US

(73) Assignee: International Business Machines Corporation, Armonk, NY

(21) Appl. No.: 09/872,561

(22) Filed: Jun. 1, 2001

(51) Int. Cl. G06F 7/00

(52) U.S. Cl. 707/104.1

(57) ABSTRACT

Disclosed are a method and system for an enterprise-wide management of document templates comprising an inheritance scheme that corresponds to the organizational structure of the enterprise. On top of the scheme, a master document class is defined. From the master document class a number of document classes are derived. From the document classes either document instances or further document classes can be derived, preferably depending on the underlying hierarchical enterprise or company organization, as described above. In the present embodiment, from the only one master document class a number of document classes doc_class1, doc_class2, . . . are derived. Exemplarily, from doc_class1 the further document class doc_class3 and the document instance doc_instance1 are created. Finally, from doc_class3 two document instances doc_instance2 and doc_instance3, are derived.

### BACKGROUND OF THE INVENTION

The invention generally relates to computer-implemented document management systems and more specifically to a method and system for enterprise-wide management of document templates.

In enterprises or companies work is usually organized in working parties or workgroups. The workgroups are distinguishing from each other with regard to the working contents or through an organizational demarcation within the enterprise. Work results are often documents which have to be administrated electronically or in paper form and to be used in successive working steps. These documents may remain only in the working sphere of the workgroup having created the document or they can be transferred to other workgroups of the enterprise or even third parties.

The document layout and processes linked to documents reflect an important issue of the administrative organization of an enterprise or company. But on the one hand, known template based document management systems do not comprise an hierarchy oriented with the underlying enterprise or company hierarchy, at least in view of organizational units like business units including the mentioned workgroups.

In addition, known approaches for managing document templates provide only predefined document structures, sometimes called “stationaries” which can be found in “.nsf”-files in Lotus Notes™. Another example is the template management system included in text processors like Microsoft Word™. The Lotus Notes approach is a non-hierarchically shared approach, where multiple people can access documents derived from one stationary. The text processor approach is optimized to be used by individuals and has therefore stronger aspects of a personal information management tool.

The above mentioned approaches are disadvantageous insofar as the limitations of the document template processing are only determined by the developer of the underlying document management system and can not be changed dynamically lateron. Further the known document management systems do not reflect an underlying enterprise workgroup hierarchy and thus do not meet the administrative requirements for document management in such an hierarchy.

### SUMMARY OF THE INVENTION

It is therefore an object of the present invention to provide a document management method and system with an improved and more efficient document template management as the prior art approaches.

It is another object to provide dynamic handling of document templates including creation and amendment of templates.

It is yet another object to provide such a method and system which reflect a given enterprise-wide workgroup hierarchy as close as possible.

These objects are attained with a method and system comprising the features of the corresponding independent claims. Advantageous embodiments are subject matter of the subclaims.

The idea underlying the invention is to provide an Enterprise-wide document template management system where management of document templates, including but not limited to the layout and contents of document templates, access rights for amending document templates etc., is reflecting top-down and/or bottom-up organizational hierarchy of the underlying enterprise or company. Top-down reflectance in the present context includes that layout and/or contents of documents or document templates reflect enterprise hierarchies like those related to enterprise or corporate identity. On the other hand, bottom-up reflectance includes network-oriented document processing by workgroups like the creation and the handling of documents derived from document templates or document templates themselves.

More particularly, the document template management method and system according to the invention provides a template hierarchy where templates are defined as document classes and documents are defined as document instances. The document classes can be used for either establishing new document classes or generating document instances therefrom. The document classes reflect properties of the document instances like paper format, header, footer, etc. These properties can be inherited from document classes to document classes or from document classes to document instances. Further processing of document classes can advantageously be restricted to certain administrators, users or even work groups by way of data access mechanisms.

As a further advantage, establishing new document classes or instances does not require a particular development environment. Also a user, in a first context being only an authorized user of a document class, in another context can even be the author of a new document class. Both, document classes and instances, can be printed or transmitted by means of a computer network, mailing system or the like. The document classes and instances are not limited to any content or layout and thus can comprise all kinds of digital information or data like files, graphics, text, tables, video or speech annotations.

In another aspect, document instances can comprise a mother-child relation which does not map an inheritance hierarchy but a document allocation hierarchy, as required for instance in electronic conferences or discussions in order to build up sets of documents which refer to each other e.g. main topic documents, responses to main topics and responses to responses.

In still another aspect of the invention, a combination of document structure and active or functional components is provided. The additional components can provide workflow-based document management and contain all aspects and properties to enable enterprise-wide document instantiation.

According to yet another aspect, the invention proposes a universal template system where master (meta) templates are used to define basic document features to be used consistently throughout a whole enterprise.

In addition, the proposed method and system enable that documents received via network transfer are automatically becoming part of a document structure provided on the receiver side.

The proposed document template management method and system provide flexible, scalable, customizable generation of document templates and instantiation of documents from those templates thus meeting necessary documents requirements in view of the underlying enterprise like its corporate identity. Further, document template design and generation can advantageously be deferred to a department of an underlying organization having special expertise therein and those already designed templates can easily be used by a workgroup for which the particular design has been made.

Furthermore, the invention allows for fast building up a framework for administrating electronic documents of arbitrary document types within a large enterprise. Nevertheless it grants sufficient freedom of action to adapt given layouts and formats of a document class to the needs of single users or entire workgroups. Thus adaptations or further developments of existing document classes can become an enterprise-wide standard by way of the aforementioned inheritance.

Finally, the scope of functionality of the proposed document management system can easily be extended through addition of active components. These active components can advantageously be used for the integration of a document template managing system in an existing system infrastructure of the underlying enterprise, for instance an existing archive system, transaction system or relational system. Document instances having such active components comprise an enhanced document processing intelligence and thus reveal automation of that processing by means of an according workflow management, as will be discussed in more detail hereinafter.

### BRIEF DESCRIPTION OF THE DRAWINGS

In the following, by making reference to the accompanied drawings, the present invention is described in more detail by way of embodiments from which further features and advantages of the invention become evident. In the drawings

FIG. 1 is a schematic overview of an exemplary enterprise organizational structure where the present invention can be applied;

FIG. 2 is a tree diagram for illustrating a typical document template inheritance scheme of a document template management system according to the invention which corresponds to the enterprise organizational structure depicted in FIG. 1;

FIG. 3 is a block diagram for illustrating the interrelationship between document templates and functional blocks in accordance with the invention;

FIG. 4 is a functional block diagram illustrating an enterprise-wide document template manager (EWDTM) according to a preferred embodiment of the invention; and

FIGS. 5a-c are snapshots of a graphical user interface for implementation of the EWDTM depicted in FIG. 4 on a Lotus Notes platform.

### DETAILED DESCRIPTION OF THE PREFERRED EMBODIMENT

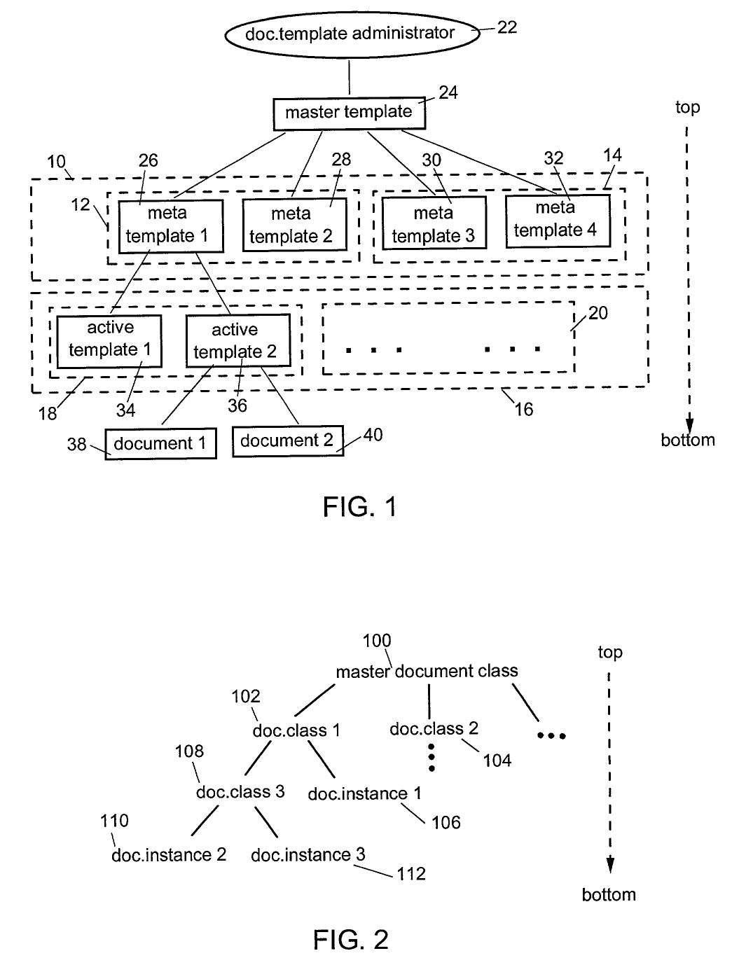

In FIG. 1 a schematic overview of an exemplary enterprise organizational or hierarchical structure, where the present invention can be applied, is shown. For simplification purposes, the organizational structure shown here, from the top to the bottom, consists of a business unit layer 10 including two business units 12, 14 and a workgroup layer 16 including two workgroups 18, 20.

On top of the organizational structure, there is arranged a so-called document template administrator 22, e.g. a human individual responsible for managing document templates throughout the enterprise. The document template administrator 22, in the present example, is the only person authorized to create a master template 24 that is valid and to be used throughout the enterprise. The master template 24, for instance, comprises a basic document layout including an common insignia or logo used for commercial or business-related identification of the whole enterprise in line with a corporate identity and other document features like a document page footer indication bank accounts or the like. However, besides the shown master template 24, principally there could be used other templates e.g. a first set of master templates relating to public correspondence documents and a second set for internal briefs.

According to the invention, for each business unit 12, 14 of the whole enterprise, meta templates 26-32 can be generated which are derived from the master template 24. For creating those meta templates 26-32, each business unit 12, 14 can have an authorized person who can use the master template 24 and to add further document features to it, but not to change the master template 24 itself. In the present example, each business unit 12, 14 has derived two meta templates (meta_template1, . . . and meta_template3, . . . ) 26, 28 and 30, 32, respectively, which comprise necessary document features to distinguish the first business unit 12 from the other business unit 14, for instance a special logo used for the respective business unit or, if the master template 24 or another master template is related to internal document based communication, typical document distribution lists or the like.

It is to be noted that the meta templates 26-32, in the present scenario, can not be used to derive documents therefrom but only to derive further meta templates, or as in the present example, so-called active templates 34, 36 which at first can be used to create documents 38, 40. The active templates 34, 36 are provided for each workgroup 18, 20 of a corresponding business unit 12, 14, like active_template 1 and active_template2 derived from meta_template1 of the first business unit 12.

Again, each workgroup 18, 20 can have an authorized person who optionally may use a corresponding meta template 26-32 and to add further document features to it in order to create an active template 34, 36, but not to change the meta template 26-32 itself.

However, it is understood hereby that the other meta templates of the business units too can be used to derive further active templates accordingly. Finally, based on each of the active templates 34, 36, documents 38, 40 can be created like documents document1 and document2 derived from active_template2.

Thus the top-down hierarchy of the shown infrastructure guarantees that the documents 38, 40 created by a member of a workgroup 18 are fully in line with an underlying enterprise document handling policy without need of any interaction by the member and without the risk that the necessary document features are changed by the member when creating the documents 38, 40.

However, it is understood that the invention can also be implemented using a reverse down-top hierarchy instead of the above mentioned top-down hierarchy. Also a common top-down hierarchy can comprise only locally (e.g. on a certain enterprise level) a reverse down-top hierarchy. For instance, pools for project groups can be established including document classes for project reports, presentations, protocols, fault tracking and change management. A centralized generation of document classes thus allows for an enterprise-wide uniform project communication and proceeding and project transceeding intelligibility. At the same time, project managers can provide new document classes in order to meet certain project requirements. These new document classes, created on the workgroup level, can be shared among project workgroups and can be transformed into an enterprise-wide new document standard if they are placed in the centralized document template top-level of the company.

It is further noted that within an enterprise a whole intranet can be mapped onto an EWDTM, or vice versa. EWDTM pools can be used as printed form container since in most enterprises, there exist a multitude of forms or questionnaires and related processes, like those concerning travel requests, travel expenses billing, office supplies orders, time clock correction notifications, contract templates, and personnel judgement forms. Using the predescribed active process component, these forms can be centrally provided as document classes for all or only selected employees.

In addition, other scenarios like establishing an electronic notice board in a shared document environment, as discussion forum or electronic manuals can be realized very fastly through configuration of document classes, as described beforehand.

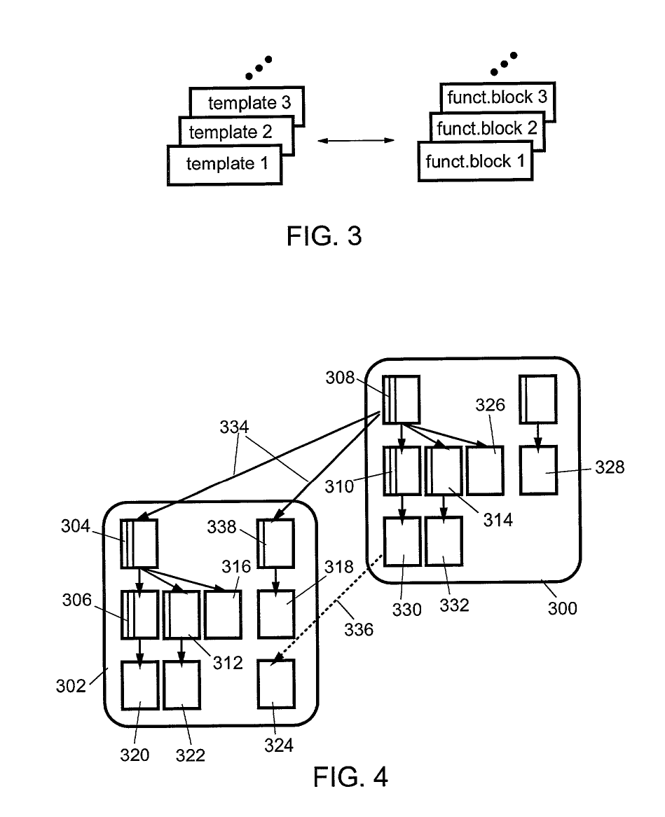

The tree diagram shown in FIG. 2 illustrates a typical document template inheritance scheme of a document template management system according to the invention which corresponds to the enterprise organizational structure depicted in FIG. 1. It is noted that, in the present embodiment, master templates, meta templates and active templates are programmed as document classes (doc_class1, . . . ) and (electronic) documents as document instances (doc_instance1, . . . ). The above described hierarchy for changing features in document classes is realized using software inheritance concepts commonly known from existing programming languages or platforms like C++.

On top of the scheme, a master document class 100 is defined. From the master document class 100 a number of document classes 102, 104 are derived. From the document classes 102, 104 either document instances 106 or further document classes 108 can be derived, preferably depending on the underlying hierarchical enterprise or company organization, as described above. In the present embodiment, from the only one master document class 100 a number of document classes doc_class1, doc_class2, . . . are derived. Exemplarily, from doc_class1 102 the further document class doc_class3 108 and the document instance doc_instance1 106 are created. Finally, from doc_class3 108 two document instances 110, 112, doc_instance2 and doc_instance3, are derived.

It is noteworthy that all derived document classes 108 and the related preceding document class 102 on the one hand and the derived document instances 106 and the related preceding document class 102 are comprising a mother-child relationship as known in the existing inheritance concepts. Therefore it is guaranteed that all minimum required document features and contents are automatically maintained by way of the predescribed inheritance scheme.

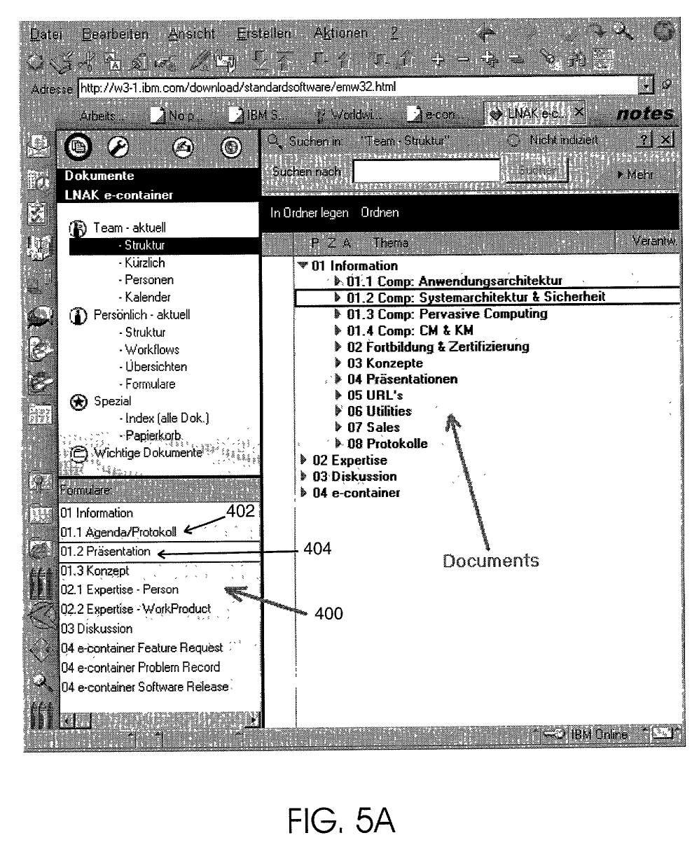

In addition to document features concerning layout of documents, it is known e.g. from Lotus Notes/Domino or Microsoft Word to link functional features or active components like document search functionality, workflow or document access authorization to single or multiple documents. The interrelationship between document templates and functional blocks in accordance with the invention is illustrated referring to FIG. 3. The predescribed concepts thus can be used also for activating certain document functions on a certain enterprise organizational level but to avoid that these functional features can be changed on a respective lower organizational level.

Active components within document classes and document instances determine either further processing of the instances or optionally can be used by the user(s) e.g. for the purposes mentioned above. Within a class it is determined which active components can be used by the derived instances. It can be chosen between a referencing component for classifying an instance by topic, structure, keywords, author, creation date, modification date, and generally referencing ordering features;

a team component for administrating access rights; if an instance contains this component, the author can determine which users can view and/or edit a document. Further it can be determined if the document can be copied, transmitted via e-Mail or printed;

a presentation component for determining the presentation style of document classes and instances exemplarily including background color and header and footer;

a status component for defining common status features like priority, responsibilities, time links and validity, release number, and textual status; the concrete embodiment like the available states can be defined in this class;

a process component, e.g. a workflow specification for each document class that determines which electronic process including administration of access rights the derived document instances have to perform; by the workflow specification it can be controlled which active components are available for which editing step; it can embrace expanding interfaces or the like;

a search component allows for automatic search for information and generation of search reports, including searches into the world wide web (WWW) or arbitrary document class pools;

an expanding interface used by developers or administrators for establishing further active components and to add these components to the respective document classes; it is possible to deactivate all predefined components and to exclusively use self-developed components.

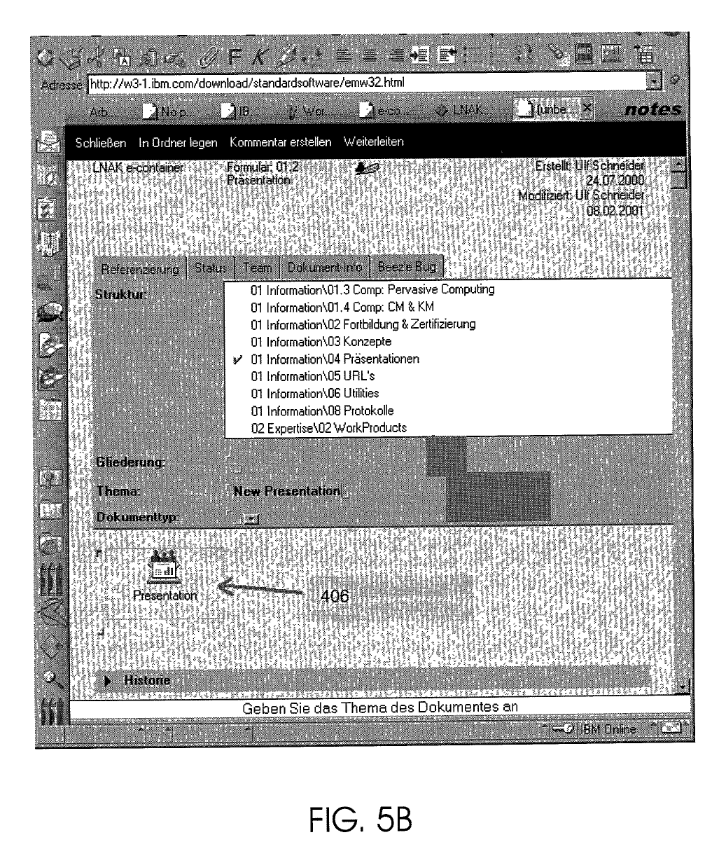

As can be seen in FIG. 4, document classes and instances are stored in closed pools. For each pool access rights can be defined that control which users have access to specific pools. Further, each pool comprises a predefined quantity of lists of contents which enable navigation to document classes and instances following different criteria. In addition, full text searches about all stored information is possible. All pools are compatible to each other and can communicate with each other and thus document classes and instances stored in one pool can be transferred to every other pool. Communication between pools can be done via user interaction or automated.

FIG. 4 is a functional block diagram illustrating an enterprise-wide document template manager (EWDTM) according to a preferred embodiment of the invention. The shown EWDTM comprises two pools, pool1 300 and pool2 302, each pool keeping meta document classes 304-310 from which further document classes 312, 314 and document instances 316-332 can be derived. The different document class and instance items are hierarchically organized within the pools 300, 302 as described above.

Each pool 300, 302 further contains document classes 312, 314 from which document instances 316-332 can be derived. Finally, each pool 300, 302 contains document instances 320, 330 which have been derived from meta document classes 306, 310 via said document classes. The relations between the shown class and instance items are depicted using arrows. Hereby the solid lines 334 depict relations between items resulting from derivation and inheritance as described above. The dotted lines 336 depicts communication relations between those items. In this embodiment, on top of its hierarchy, pool1 300 comprises a meta document class 308 which, on the one hand is used to derive a further meta document class 306, a document class 312 and a document instance 316.

On the other hand, meta document class 308 has two item derivation and inheritance relations 334 to pool2 302, the first one used for deriving a correspondent meta document class 304 and the second one used to derive a document class 338 in pool2 302. As one can also gather from FIG. 4, derived meta document classes 306, 310 both in pool1 300 and pool2 302 are used to derive document instances 320, 330 without requiring an intermediate step of deriving a document class first from the corresponding meta document class.

Within each pool 300, 302, a rule based control system can be implemented that controls treatment of received document classes and instances. For instance, it can be ruled that a document instance received from a pool 300, 302 is assigned a certain different class than the class with which the instance has been established.

The pools and their contents can be integrated in a messaging system of the underlying enterprise so that document classes and instances can be transmitted via email. Only exemplarily it is referred to a situation where a new software release of the present EWDTM is distributed in the enterprise. Together with such a distribution, a so-called ‘master pool’ is provided. By means of the master pool design information can be inherited to the other pools existing within the enterprise. But that inheritance relation between the master pool and the other pools can be deactivated for a single or multiple pools. New pools can be generated using the master pool similarity as generation of document instances from document classes.

It should be noted that the above described EWDTM system can be accessed with a Web browser. Editing and processing templates or documents derived therefrom hereby can be accomplished by means of a gateway that allows to dynamically present the contents of an underlying EWDTM System using a web browser. The advantage of that approach is that it enables use of standardized clients and transmission protocols for handling all transactions needed to run the EWDTM. Nowadays, most enterprises and companies have implemented web browsers on their computer workstations so that it is only required to install an EWDTM system server on the existing computer systems. In addition, the mentioned standards even enable to establish an extranet using the described EWDTM technology.

The type of inheritance of document class properties can be determined for pools, classes and instances. The according settings can be done one-time during creation of a pool, document class or instance, ad-hoc by way of user interaction, time controlled after a predetermined schedule or automatically after having changed a class from which a further class or an instance has been derived.

A new setting in a document instance overwrites an existing setting of the underlying document class and a new setting in a document class overwrites the setting of the respective storing pool.

When a class is established in a pool, at first the inheritance settings of the pool are valid. But these settings can be overwritten in the document class. In the document class it is determined which inheritance relation is valid for derived document instances and if these settings can be overwritten by a user.

Within a pool, a document class can newly be established or created in the same or another pool using a so-called meta class. The difference between meta classes and classes lies in that meta classes can be used to establish new classes or instances whereby classes can be used only for generating instances. In order to distinguish which users are authorized to use a meta class for establishing a new class and which users are only authorized to derive an instance from a meta class is controlled by an access authorization mechanism.

Document instances can be transferred automatically from one pool in another pool and/or can be duplicated. If an instance exceeds the border of a pool, a rule based mechanism can modify the instance as required by the current pool. This includes assignment of the instance to another class than the class with which the instance has been created originally or includes modification of single contents and of active components. A pool can also incorporate documents originating from other electronic systems like e-mail systems. In addition, pools can be defined as e-mail receivers having an own e-mail address. The rule based mechanism in such a scenario guarantees orderly administration and presentation of received information. The rule based mechanism thereupon can check particular information of received documents and/or performing a textual search about the whole content of the received documents and, depending therefrom, determine an applicable rule.

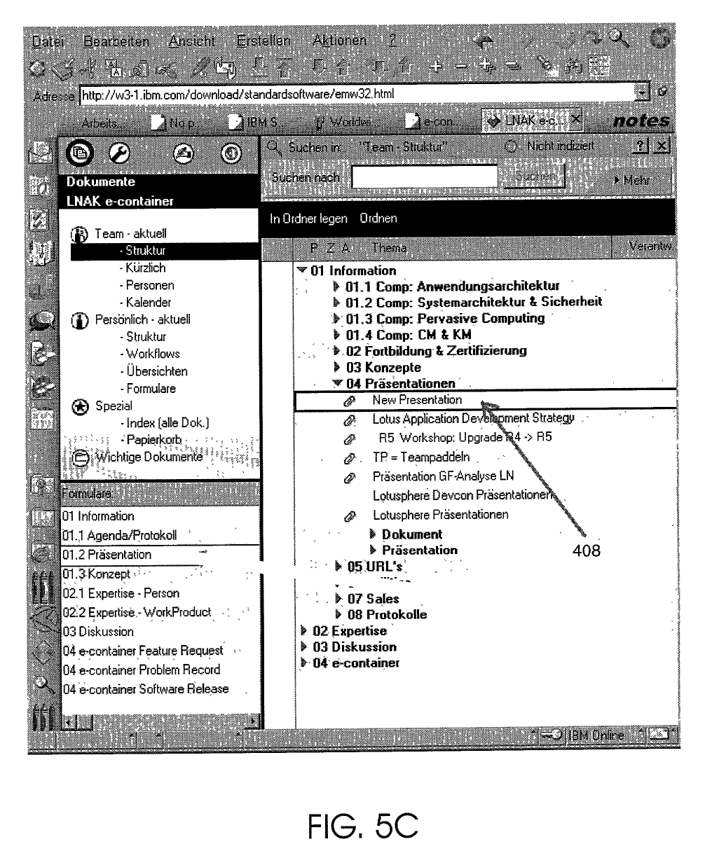

FIGS. 5a-5c depict different views of an exemplary graphical user interface (GUI) for accessing or using the EWDTM shown in FIG. 4 by a member of a workgroup of an enterprise not having administrative rights to edit a master template or a meta template of a business unit but to edit or create new templates in the workgroup level as described above. The shown EWDTM is implemented using Lotus Notes/Domino in the form of a database template referred to as “e-Container”.

The left-hand bottom column 400 in the GUI view shown in FIG. 5a entitled “Formulare” presents a list of template documents of different kinds, e.g. a protocol template 402 and a presentation template 404. To create a new presentation document, the user has to double-click in the “01.2 Prasentation” row. This will open the template for presentation documents 406 as shown in FIG. 5b. In this example some selectable pre-settings for categorization of the document have been made and a Freelance OLE presentation object has been prepared in the template. The OLE contains the standard for presentation layouts of the workgroup and can instantly be used by double-clicking on it. If the presentation document is stored in the database, a new document is being created based on the layout and settings of the “01.2 Prasentation” template document (FIG. 5c). The navigation to this document is standardized by the categories, which were provided in the template and has been derived to the new document.

1. A method for managing document templates within an enterprise having an enterprise hierarchy, characterized in that providing meta templates from which active templates are derived thus instantiating documents therefrom, wherein said meta templates and said active templates are arranged in accordance with said enterprise hierarchy.

2. Method according to claim 1, wherein templates are defined as document classes and documents are defined as document instances.

3. Method according to claim 2, wherein said document classes are used for either establishing new document classes or generating document instances therefrom.

4. Method according to claim 3, wherein said document classes reflect properties of the document instances which are inherited from document classes to document classes or from document classes to document instances.

5. Method according to claim 4, wherein processing of document classes is restricted using a data access mechanism.

6. Method according to claim 1, wherein providing at least one master meta template used to define basic document features to be used consistently throughout the enterprise.

7. Method according to claim 1, wherein generating from said active templates activities by selecting activity definitions for said meta templates, said activity definitions including but not limited to enterprise-wide search, workflow-based document management, enterprise-wide document instantiation and document or document template access authorization.

8. Method according to claim 1, wherein document instances comprise a mother-child relation mapping a document allocation hierarchy.

9. Method according to claim 1, wherein document templates or documents received on a receiving side automatically become part of a document structure provided on the receiving side.

10. A data processing program for execution in a data processing system comprising software code portions for performing a method according to any of claims 1 to 9 when said program is run on said computer.

11. A computer program product stored on a computer usable medium, comprising computer readable program means for causing a computer to perform a method according to any of claims 1 to 9 when said program is run on said computer.

12. A document management system for managing document templates within an enterprise having an enterprise hierarchy, characterized in that providing meta templates from which active templates are derived thus instantiating documents therefrom, wherein said meta templates and said active templates are arranged in accordance with said enterprise hierarchy.

13. System according to claim 12, comprising document classes for defining templates and document instances for defining documents.

14. System according to claim 13, wherein said document classes reflect properties of the document instances which are inherited from document classes to document classes or from document classes to document instances.

15. System according to claim 14, comprising a data access mechanism for restricting processing of document classes.

16. System according to claim 12, comprising at least one master meta template used to define basic document features to be used consistently throughout the enterprise.

17. System according to claim 12, comprising activities generated from said active templates by selecting activity definitions for said meta templates, said activity definitions including but not limited to enterprise-wide search, workflow-based document management, enterprise-wide document instantiation and document or document template access authorization.

18. System according to claim 12, wherein said document instances comprise a mother-child relation mapping a document allocation hierarchy.
